(19) United States
(12) Patent Application Publication
(10) Pub. No.: US 2024/0430210 A1
(43) Pub. Date: Dec. 26, 2024

(54) TRAFFIC MANAGEMENT AND CONTROL METHOD AND APPARATUS, AND DEVICE AND READABLE STORAGE MEDIUM

(71) Applicant: SUZHOU METABRAIN INTELLIGENT TECHNOLOGY CO., LTD., Jiangsu (CN)

(72) Inventors: Wei GUO, Jiangsu (CN); Yaming XU, Jiangsu (CN); Wei LIU, Jiangsu (CN)

(21) Appl. No.: 18/706,122

(22) PCT Filed: Nov. 11, 2022
(86) PCT No.: PCT/CN2022/131551

§ 371 Date: Apr. 30, 2024

(30) Foreign Application Priority Data
Mar. 31, 2022 (CN) 202210331087.5

(51) Int. Cl. H04L 47/52; H04L 47/10

(52) U.S. Cl. CPC H04L 47/52; H04L 47/10

(57) ABSTRACT

The present disclosure provides a method and apparatus for traffic management and control method, device and readable storage medium. The method includes: acquiring a data frame sent from a heterogeneous accelerator; selecting a target traffic management and control mode corresponding to data in the data frame from a plurality of preset traffic management and control modes; and managing and controlling the data in the data frame according to the target traffic management and control mode, so as to allocate the data to a QDMA queue, and send the data by the QDMA queue, and process the data by a corresponding CPU core.

### CROSS-REFERENCE TO RELATED APPLICATION

The present disclosure claims priority to Chinese patent application no. 202210331087.5, filed with the Chinese Patent Office on Mar. 31, 2022 and entitled “Method and Apparatus for Traffic Management and Control, Device and Readable Storage Medium”, which is incorporated herein by reference in its entirety.

### TECHNICAL FIELD

The present disclosure relates to the technical field of traffic management and control, and in particular, to a method and apparatus for traffic management and control, device and readable storage medium.

### BACKGROUND

In a heterogeneous accelerator implemented by using an Field-Programmable Gate Array (FPGA), the design of the FPGA is generally divided into a shell part and a dynamic kernel part.

For a shell in an FPGA heterogeneous accelerator, a common shell at present uses a conventional Direct Memory Access (DMA) interface to map a memory resource on the FPGA accelerator to a host Central Processing Unit (CPU) by means of an internal AXI-Memory Map (AXI-MM) interface, and an operating system performs scheduling to determine a CPU core to which the resource is allocated. The data exchange between the CPU and the dynamic kernel needs to be cached via memory resource on the FPGA accelerator.

However, the inventor realizes that the bandwidth for the host to access the onboard RAM in the FPGA is completely shared with all the kernels, basically without any traffic management and control capability. At present, an improved shell uses a Queue-DMA (QDMA) interface, and an additional AXI-Stream (AXIS) interface is added. A kernel designed by a user can be directly connected to an AXIS interface, so that user data is directly exchanged with a CPU memory, without needing to be cached via the memory resource on the FPGA accelerator. Although the network data may enter a dedicated queue of the transmission channel, there are no management and control mechanism and bandwidth allocation mechanism used for the queue. From the described process, it can be determined that the existing FPGA heterogeneous accelerator still has the very insufficient capability of processing and managing and controlling network traffic, and therefore the performance cannot be effectively improved.

### SUMMARY

In an embodiment, the present disclosure provides a method for traffic management and control, including:
acquiring a data frame sent from a heterogeneous accelerator;
selecting a target traffic management and control mode corresponding to data in the data frame from a plurality of preset traffic management and control modes; and
managing and controlling the data in the data frame according to the target traffic management and control mode, so as to allocate the data to a QDMA queue, and send the data by the QDMA queue, and process the data by a corresponding CPU core.

In an embodiment, when a bandwidth of data in a data frame sent from a single kernel of the heterogeneous accelerator is greater than a first preset value and exceeds a processing capability of a single CPU core, selecting a target traffic management and control mode corresponding to data in the data frame from a plurality of preset traffic management and control modes, including:
selecting an RSS hash preset extension mode from the plurality of preset traffic management and control modes as a target traffic management and control mode corresponding to the data in the data frame;
managing and controlling the data in the data frame according to the target traffic management and control mode, so as to allocate the data to a QDMA queue, send the data by the QDMA queue, including:
obtaining a minimum required number of CPU cores according to a maximum processing bandwidth and a set processing bandwidth of a single CPU core, and reserving CPU cores and QDMA queues according to the minimum required number of CPU cores;
performing RSS hashing on the data in the data frame according to the number of reserved CPU cores to obtain first data hashes; and
allocating each first data hash to a reserved QDMA queue, and sending, by the QDMA queue, the first data hash to a cache region corresponding to the QDMA queue in a system memory, so that the CPU core pre-bound to the QDMA queue acquires data from the corresponding cache region and processes same; wherein the cumulative bandwidth in each reserved QDMA queue does not exceed the set processing bandwidth of a single CPU core.

In an embodiment, performing RSS hashing on the data in the data frame according to the number of reserved CPU cores, including:
performing RSS hashing on the data in the data frame according to N times the number of the reserved CPU cores; where N is an integer greater than 1;
before allocating each first data hash to a reserved QDMA queue, further including: performing bandwidth statistics on each first data hash, and regularly performing statistics update on the bandwidth of each first data hash;
allocating each first data hash to a reserved QDMA queue, including:
sequentially allocating each first data hash to the reserved QDMA queue in a descending order of bandwidths; wherein before a current first data hash is allocated to a current QDMA queue, whether the cumulative bandwidth of the current QDMA queue after the current first data hash is allocated thereto exceeds the set processing bandwidth of a single CPU core is determined; and
in response to that the cumulative bandwidth of the current QDMA queue after the current first data hash is allocated thereto does not exceed the set processing bandwidth of a single CPU core, allocating the current first data hash to the current QDMA queue; taking the next first data hash as the current first data hash, and taking the reserved next QDMA queue as the current QDMA queue, executing the step that before the current first data hash is allocated to the current QDMA queue, whether the cumulative bandwidth of the current QDMA queue after the current first data hash is allocated thereto exceeds the set processing bandwidth of a single CPU core is determined, until all the first data hashes are allocated to the reserved QDMA queues; or, in response to that the cumulative bandwidth of the current QDMA queue after the current first data hash is allocated thereto exceeds the set processing bandwidth of a single CPU core, taking the reserved next QDMA queue as the current QDMA queue, and executing the step that before the current first data hash is allocated to the current QDMA queue, whether the cumulative bandwidth of the current QDMA queue after the current first data hash is allocated thereto exceeds the set processing bandwidth of a single CPU core is determined.

In an embodiment, when a bandwidth of data in a data frame sent from a single kernel of the heterogeneous accelerator does not exceed the processing capability of a single CPU core, and the total bandwidth of data in data frames sent from a plurality of kernels is greater than a second preset value, selecting a target traffic management and control mode corresponding to data in the data frame from a plurality of preset traffic management and control modes, including:
selecting an RSS hash dynamic extension mode from the plurality of preset traffic management and control modes as a target traffic management and control mode corresponding to the data in the data frame;
managing and controlling the data in the data frame according to the target traffic management and control mode, so as to allocate the data to a QDMA queue, send the data by the QDMA queue, including:
merging the data in the data frames sent from the plurality of kernels, and performing RSS hashing on the merged data to obtain second data hashes; performing bandwidth statistics on each second data hash, and allocating the second data hash to a first QDMA queue in a descending order of bandwidths, and in response to obtaining by means of calculation, before a current second data hash is allocated, that the cumulative bandwidth of the first QDMA queue after the current second data hash is allocated thereto exceeds the set processing bandwidth of a single CPU core, starting a next QDMA queue, and allocating the remaining second data hashes to the newly enabled QDMA queue in a descending order of bandwidths, until all the second data hashes are completely allocated; wherein the cumulative bandwidth in each QDMA queue does not exceed the set processing bandwidth of a single CPU core; and
sending, by the QDMA queue to which the second data hash is allocated, the corresponding second data hash to a cache region corresponding to the QDMA queue in a system memory, so that the CPU core pre-bound to the QDMA queue acquires data from the corresponding cache region and processes the data.

In an embodiment, when a required delay of data in the data frame sent from a single kernel of the heterogeneous accelerator is less than a third preset value and a bandwidth of the data does not exceed the processing capability of a single CPU core, selecting a target traffic management and control mode corresponding to data in the data frame from a plurality of preset traffic management and control modes, including:
selecting a designated queue direct mapping mode from the plurality of preset traffic management and control modes as a target traffic management and control mode corresponding to the data in the data frame; and
managing and controlling the data in the data frame according to the target traffic management and control mode, so as to allocate the data to a QDMA queue, send the data by the QDMA queue, including:
directly distributing the data in the data frame sent from each kernel to a designated QDMA queue, and sending, by means of the QDMA queue, the data to a cache region corresponding to the QDMA queue in a system memory, so that the CPU core pre-bound to the QDMA queue acquires data from the corresponding cache region and processes the data.

In an embodiment, when it is required that a bandwidth of data in a data frame sent from a single kernel of the heterogeneous accelerator does not exceed a fourth preset value, selecting a target traffic management and control mode corresponding to data in the data frame from a plurality of preset traffic management and control modes, including:
selecting a queue bandwidth rate-limiting mode from the plurality of preset traffic management and control modes as a target traffic management and control mode corresponding to the data in the data frame;
managing and controlling the data in the data frame according to the target traffic management and control mode, so as to allocate the data to a QDMA queue, send the data by the QDMA queue, including:
limiting the bandwidth of the data by using a token bucket algorithm, and sending the data after the bandwidth is limited to a designated QDMA queue; and
sending the data after the bandwidth is limited to a system memory by means of the QDMA queue, and scheduling a CPU core, so that the scheduled CPU core acquires data from the system memory and processes the data.

In an embodiment, the method further includes:
recording a queue number of a QDMA queue to which the data is allocated and a virtual source port included in the data frame, so as to obtain record information; and
when the CPU sends a data stream to the heterogeneous accelerator, sending data in the data stream to a corresponding heterogeneous accelerator kernel according to the record information.

In another embodiment, the present disclosure provides an apparatus for traffic management and control, including:
an acquisition module, configured to acquire a data frame sent from a heterogeneous accelerator;
a selection module, configured to select a target traffic management and control mode corresponding to data in the data frame from a plurality of preset traffic management and control modes; and
a management and control module, configured to manage and control the data in the data frame according to the target traffic management and control mode, so as to allocate the data to a QDMA queue, and send the data by the QDMA queue, and process the data by a corresponding CPU core.

In another embodiment, the present disclosure provides a device for traffic management and control, including:
a memory, configured to store computer readable instructions; and
one or more processors, configured to implement steps of the traffic management and control method when executing the computer readable instructions.

One or more non-transitory computer readable storage media storing computer readable instructions which, when executed by one or more processors, cause the one or more processors to perform steps of the method for traffic management and control.

Details of one or more embodiments of the present disclosure are set forth in the drawings and the description below. Other features and advantages of the present disclosure will become apparent from the description, the drawings, and the claims.

### BRIEF DESCRIPTION OF THE DRAWINGS

To describe the technical solutions in the embodiments of the present disclosure or in the prior art more clearly, the following briefly introduces the drawings required for description in the embodiments or the prior art. Apparently, the drawings in the following description show merely some embodiments of the present disclosure, and a person of ordinary skill in the art may still derive other drawings from the provided drawings without inventive efforts.

FIG. 1 is a flowchart of a method for traffic management and control provided in one or more embodiments of the present disclosure;

FIG. 2 is a block diagram of a shell implementation supporting traffic management and control provided in one or more embodiments of the present disclosure;

FIG. 3 is a schematic structural diagram of an apparatus for traffic management and control provided in one or more embodiments of the present disclosure; and

FIG. 4 is a schematic structural diagram of a device for traffic management and control provided in one or more embodiments of the present disclosure.

### DETAILED DESCRIPTION OF THE EMBODIMENTS

In a heterogeneous accelerator using an FPGA, the design of the FPGA is generally divided into a shell part and a dynamic kernel part. The shell part implements a basic FPGA accelerator management function and a data channel for a host, wherein the basic management function includes managing download of a dynamic region kernel, programming flash chips, and saving a shell version used by power-on, which implements message communications between a drive of management permissions and a drive of user permissions, and the data channel implements a Peripheral Component Interconnect express (PCIe) Direct Memory Access (DMA) transmission channel between the host and the dynamic kernel. The dynamic kernel part implements various functions defined by a user, and generally, a plurality of kernels form a system by means of parallel connection or series connection for implementing a specific function. The dynamic kernel part manages an onboard Double Data Rate (DDR) memory interface, a high-bandwidth memory in a chip, and a high-speed serial transmission interface. Dynamic switching of all user functions and systems can be achieved by means of FPGA programming, so that an FPGA-based heterogeneous accelerator has powerful universality and flexibility. The current FPGA accelerators all have the access and processing capabilities of a network interface, but still have a very insufficient capability of processing and managing and controlling network traffic.

A common shell at present uses a conventional DMA interface to map a memory resource on the FPGA accelerator to a host Central Processing Unit (CPU) by means of an internal Advanced Extensible Interface-Memory Map (AXI-MM) interface, and an operating system performs scheduling to determine a CPU core to which a resource is allocated. The data exchange between the CPU and the dynamic kernel needs to be cached via a memory resource on the FPGA accelerator. However, the bandwidth for the host to access the onboard RAM in the FPGA is completely shared with all the kernels, basically without any traffic management and control capability. At present, an improved shell uses a Queue-DMA (QDMA) interface, and an additional AXIS interface is added. A kernel designed by a user can be directly connected to an AXIS interface, so that user data is directly exchanged with a CPU memory, without needing to be cached via a memory resource on the FPGA accelerator. Although the network data may enter a dedicated queue of the transmission channel, there are no management and control mechanism and bandwidth allocation mechanism used for the queue, and the bandwidth is basically allocated in a polling manner.

To this end, the present disclosure provides a method and apparatus for traffic management and control, device and readable storage medium, which are used for managing and controlling traffic in a direction from a heterogeneous accelerator to a CPU, so as to improve data stream processing performance and maintain a CPU core to run in a reasonable load interval.

The following clearly and completely describes the technical solutions in the embodiments of the present disclosure with reference to the drawings in the embodiments of the present disclosure. Apparently, the described embodiments are merely some rather than all of the embodiments of the present disclosure. All other embodiments obtained by a person of ordinary skill in the art based on the embodiments of the present disclosure without inventive efforts shall belong to the scope of protection of the present disclosure.

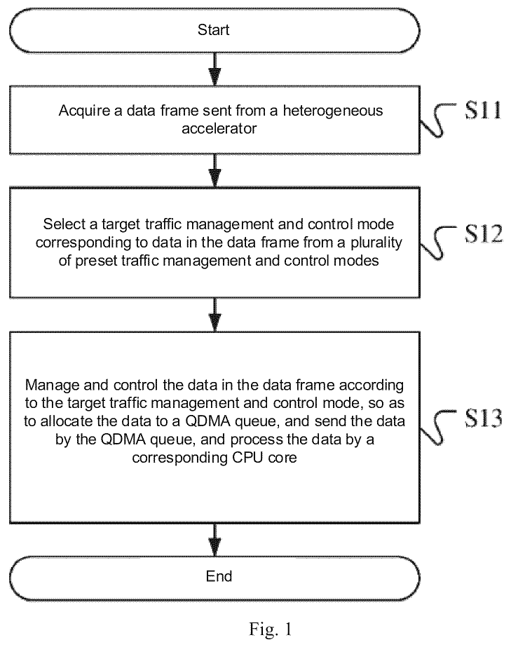

FIG. 1 shows a flowchart of a method for traffic management and control provided in an embodiment of the present disclosure. A method for traffic management and control provided in an embodiment of the present disclosure may include:

S11: acquire a data frame sent from a heterogeneous accelerator.

In an embodiment, a traffic management and control function is mainly implemented in a Card to Host (C2H) direction, that is, the traffic entering a CPU from a heterogeneous accelerator is mainly managed and controlled, so as to improve data stream processing performance and maintain a CPU core to run in a reasonable load interval. It should be noted that the heterogeneous accelerator mentioned in traffic management and control in the present disclosure refers to an FPGA heterogeneous accelerator, and certainly, may also be other heterogeneous accelerators.

During the traffic management and control, a data frame sent from the heterogeneous accelerator may be acquired first, and specifically, a data frame in a C2H direction sent from a kernel of the heterogeneous accelerator may be acquired, and an AXI-ST (i.e. AXI-Stream) interface format may be used. In addition, the data frame may further carry information about a virtual destination port and a virtual source port, so as to facilitate acquiring relevant information from the information and facilitate recording of the information.

S12: select a target traffic management and control mode corresponding to data in the data frame from a plurality of preset traffic management and control modes.

When traffic management and control is performed, a plurality of traffic management and control modes may be preset. Specifically, an RSS hash preset extension mode, an RSS hash dynamic extension mode, a designated queue direct mapping mode, and a queue bandwidth rate-limiting mode may be set as the traffic management and control modes.

On the basis of step S11, a target traffic management and control mode corresponding to data in the data frame may be selected from a plurality of preset traffic management and control modes, so as to implement management and control of data in the data frame on the basis of the selected target traffic management and control mode.

When a target traffic management and control mode is selected, a target traffic management and control mode corresponding to data in the data frame may be automatically selected from a plurality of preset traffic management and control modes according to a bandwidth or a delay of the data in the data frame, so as to select a traffic management and control mode which is most adapted to the data in the data frame, thereby improving data stream processing performance and maintaining a CPU core to run in a reasonable load interval. Certainly, a target traffic management and control mode corresponding to data in the data frame may also be selected from a plurality of preset traffic management and control modes according to user requirements. Specifically, a target traffic management and control mode selection instruction may be received, and a target traffic management and control mode corresponding to data in the data frame is selected from a plurality of preset traffic management and control modes according to the target traffic management and control mode selection instruction, so as to implement traffic management and control while satisfying the user requirements, thereby improving user experience, and relatively improving data stream processing performance and maintaining a CPU core to run in a reasonable load interval. When a target traffic management and control mode is selected from a plurality of preset traffic management and control modes according to the user requirements, a system may also first recommend, according to a bandwidth and a delay of data in the data frame, a traffic management and control mode which is most adapted to the data in the data frame from the plurality of preset traffic management and control modes, so that the user can select, on the basis of the recommendation, the traffic management and control mode which is most adapted to the data in the data frame.

S13: manage and control the data in the data frame according to the target traffic management and control mode, so as to allocate the data to a QDMA queue, and send the data by the QDMA queue, and process the data by a corresponding CPU core.

After the target traffic management and control mode corresponding to the data in the data frame is selected, the data in the data frame may be managed and controlled according to the target traffic management and control mode, so that, by means of management and control, the data in the data frame is allocated to a QDMA queue, and the data is sent to a system memory by the QDMA queue, and a corresponding CPU core that is available acquires corresponding data from the system memory and processes the data.

From the described process, it can be determined that the present disclosure realizes data management and control on the basis of a target traffic management and control mode selected from a plurality of preset traffic management and control modes, and can reasonably allocate data to a QDMA queue by means of management and control, and reasonably allocate data allocated to the QDMA queue to an available CPU core, thereby improving data stream processing performance and maintaining a CPU core to run in a reasonable load interval.

In the described technical solution disclosed in an embodiment, a plurality of traffic management and control modes are preset; when a data frame sent from a heterogeneous accelerator is acquired, a target traffic management and control mode is selected from the preset plurality of traffic management and control modes, and the traffic in a direction from the heterogeneous accelerator to a CPU is managed and controlled according to the selected target traffic management and control mode; and by means of management and control, data is reasonably allocated to a QDMA queue, then the data is sent by the QDMA queue, and a corresponding CPU core processes the data transmitted by the QDMA queue, so that the data is allocated to an available CPU core and data processing is performed by using the available CPU core, thereby enabling a data stream to obtain a matched CPU operation resource, further improving data stream processing performance and maintaining a CPU core to run in a reasonable load interval.

FIG. 2 shows a block diagram of a shell implementation supporting traffic management and control provided in an embodiment of the present disclosure. According to the method for traffic management and control provided in an embodiment of the present disclosure, when a bandwidth of data in a data frame sent from a single kernel of the heterogeneous accelerator is greater than a first preset value and exceeds a processing capability of a single CPU core, selecting a target traffic management and control mode corresponding to data in the data frame from a plurality of preset traffic management and control modes may include: selecting an RSS hash preset extension mode from the plurality of preset traffic management and control modes as a target traffic management and control mode corresponding to the data in the data frame;
managing and controlling the data in the data frame according to the target traffic management and control mode, so as to allocate the data to a QDMA queue, send the data by means of the QDMA queue may include:
obtaining a minimum required number of CPU cores according to a maximum processing bandwidth and a set processing bandwidth of a single CPU core, and reserving CPU cores and QDMA queues according to the minimum required number of CPU cores;
performing RSS hashing on the data in the data frame according to the number of reserved CPU cores to obtain first data hashes;
allocating each first data hash to a reserved QDMA queue, and sending, by the QDMA queue, the first data hash to a cache region corresponding to the QDMA queue in a system memory, so that the CPU core pre-bound to the QDMA queue acquires data from the corresponding cache region and processes the data; wherein the cumulative bandwidth in each reserved QDMA queue does not exceed the set processing bandwidth of a single CPU core.

In an embodiment, when a target traffic management and control mode corresponding to data in the data frame is selected from a plurality of preset traffic management and control modes, if a target traffic management and control mode corresponding to data in the data frame is automatically selected from the plurality of preset traffic management and control modes according to a bandwidth of data in the data frame, when the bandwidth of data in the data frame sent from a single kernel of the heterogeneous accelerator is greater than a first preset value (the specific magnitude thereof is set according to practical experience, and the bandwidth being greater than the first preset value indicates a CPU response requirement with a high bandwidth) and the bandwidth of data in the data frame sent from the single kernel of the heterogeneous accelerator exceeds the processing capability of a single CPU core (the processing capability can be characterized by a processing bandwidth), an RSS (Receive Side Scaling) hash mode is selected from the plurality of preset traffic management and control modes as the target traffic management and control mode corresponding to the data in the data frame.

Correspondingly, when the data in the data frame is managed and controlled according to the target traffic management and control mode, so as to allocate the data to a QDMA queue, and send the data by means of the QDMA queue, a minimum required number of CPU cores is obtained by dividing a maximum processing bandwidth required by a single kernel of the heterogeneous accelerator by a set processing bandwidth of a single CPU core, and CPU cores and QDMA queues are reserved according to the minimum required number of CPU cores, wherein the number of reserved CPU cores is equal to the number of reserved QDMA queues, and the reserved CPU cores are bound to the reserved QDMA queues by using the affinity of the CPU (specifically, a core number of a CPU cores can be bound to a queue number of a QDMA queue by using the affinity of the CPU in software of a host system), so that each reserved CPU core can respectively have a QDMA queue corresponding thereto, and the number of reserved CPU cores is greater than or equal to the minimum required number of CPU cores, so that the number of reserved CPU cores can satisfy the processing requirements of the data in the data frame sent from the foregoing kernel. Then, RSS hashing is performed on the data in the data frame according to the number of reserved CPU cores (specifically, hashing is performed on the basis of a data feature) to obtain first data hashes, wherein the number of the first data hashes is not less than the number of reserved CPU cores (in other words, the number of the first data hashes is also not less than the number of reserved QDMA queues), so that at least one first data hash is allocated to each reserved QDMA queue, and each reserved CPU core can acquire corresponding data and process the data. After the first data hashes are obtained, each first data hash may be allocated to a reserved QDMA queue, wherein at least one first data hash is allocated to each QDMA queue, and may be specifically allocated to a queue number of the QDMA queue when allocation is performed, and the cumulative bandwidth in each reserved QDMA queue does not exceed the set processing bandwidth of a single CPU core (i.e. a total data bandwidth allocated to each reserved QDMA queue does not exceed the set processing bandwidth of a single CPU core), so that a data bandwidth processed by a single CPU core does not exceed the processing capability of the single CPU core, thereby enabling the CPU core to effectively and reliably process the allocated data. After each first data hash is allocated to a reserved QDMA queue, the first data hash is sent, by means of the QDMA queue, to a cache region corresponding to the QDMA queue in a system memory (i.e. each reserved QDMA queue has a corresponding cache region in the system memory), so that the corresponding first data hash is cached by using the corresponding cache region, and a reserved CPU core pre-bound to the reserved QDMA queue acquires data from the corresponding cache region (specifically, acquiring a first data hash), and processes the acquired data.

By means of the described process, data in the data frame sent from a single kernel can be hashed and allocated to each reserved QDMA queue, and scheduling processing is performed by each reserved CPU core, so as to ensure that the bandwidth and the processing delay satisfy an application requirement to the maximum extent. In addition, as sufficient CPU cores are reserved to be specially responsible for processing data sent from a single core, an optimal processing performance is provided. In addition, a plurality of cores of a CPU are configured into a plurality of QDMA queues as required by means of the introduction of an RSS hash preset extension mode and the traffic management and control according to the mode, thereby realizing the coordinated configuration of the CPU and the heterogeneous accelerator capabilities. It should be noted that, the management and control mode selection in FIG. 2 corresponds to the selection of a target traffic management and control mode from a plurality of preset traffic management and control modes, and the RSS hash preset extension corresponds to an RSS hash preset extension mode.

According to the method for traffic management and control provided in an embodiment of the present disclosure, performing RSS hashing on the data in the data frame according to the number of reserved CPU cores may include:
performing RSS hashing on the data in the data frame according to N times the number of the reserved CPU cores; where N is an integer greater than 1;
before allocating each first data hash to a reserved QDMA queue, the method may further include:
performing bandwidth statistics on each first data hash, and regularly performing statistics update on the bandwidth of each first data hash;
allocating each first data hash to a reserved QDMA queue may include:
sequentially allocating each first data hash to the reserved QDMA queue in a descending order of bandwidths; wherein before a current first data hash is allocated to a current QDMA queue, whether the cumulative bandwidth of the current QDMA queue after the current first data hash is allocated thereto exceeds the set processing bandwidth of a single CPU core is determined;
if not, allocating the current first data hash to the current QDMA queue; taking the next first data hash as the current first data hash, and taking the reserved next QDMA queue as the current QDMA queue, executing the step that before the current first data hash is allocated to the current QDMA queue, whether the cumulative bandwidth of the current QDMA queue after the current first data hash is allocated thereto exceeds the set processing bandwidth of a single CPU core is determined, until all the first data hashes are allocated to the reserved QDMA queues;
if so, taking the reserved next QDMA queue as the current QDMA queue, and executing the step that before the current first data hash is allocated to the current QDMA queue, whether the cumulative bandwidth of the current QDMA queue after the current first data hash is allocated thereto exceeds the set processing bandwidth of a single CPU core is determined.

Considering that RSS hashing may be uneven, and in order to enable an equal amount of data to be allocated to each reserved QDMA queue as much as possible, when RSS hashing is performed on the data in the data frame according to the number of reserved CPU cores, RSS hashing may be performed on the data in the data frame according to N times the number of the reserved CPU cores, where N is an integer greater than 1, and N may specifically be greater than or equal to 4. After RSS hashing is performed according to N times the number of the reserved CPU cores to obtain the first data hashes, bandwidth statistics may be performed on each obtained first data hash. As the bandwidth (i.e. data traffic) of data sent by the data frame changes continuously, statistics update may be performed regularly on the bandwidth of each first data hash (wherein the frequency at which statistics update is performed on the bandwidth of each first data hash is not lower than 10 Hz, i.e. the periodical frequency is not lower than 10 Hz), so as to adjust and update the QDMA queue allocation for each first data hash on the basis of the bandwidth of each second data hash on which statistics update has been performed, thereby enabling an equal amount of data to be allocated to each reserved QDMA queue as much as possible.

After bandwidth statistics is performed on each first data hash, when the first data hash is allocated, each first data hash may be sequentially allocated to the reserved QDMA queue in a descending order of bandwidths (certainly, allocation may also be performed in an ascending order of bandwidths), so that data of which the bandwidth has little difference and of which the cumulative bandwidth does not exceed the set processing bandwidth of a single CPU core can be allocated to each reserved QDMA queue as much as possible, and each reserved CPU core can process, as much as possible, an equal amount of data not exceeding the set processing bandwidth thereof, thereby improving data stream processing performance and maintaining a CPU core to run in a reasonable load interval.

When each first data hash is sequentially allocated to the reserved QDMA queue in a descending order of bandwidths, the first data hash is first taken as a current data hash in the descending order of bandwidths, and the reserved first QDMA queue is taken as a current QDMA queue; before the current data hash is allocated to the current QDMA queue, it is first determined whether the cumulative bandwidth of the current QDMA queue after the current first data hash is allocated thereto (the cumulative bandwidth after the current first data hash is allocated thereto is the sum of the bandwidth of the allocated first data hash and the bandwidth of the current first data hash) exceeds the set processing bandwidth of a single CPU core;
if the cumulative bandwidth of the current QDMA queue after the current first data hash is allocated thereto does not exceed the set processing bandwidth of a single CPU core, in this case, the current first data hash may be allocated to the QDMA queue, then the next data hash may be taken as the current data hash in a descending order of bandwidths, the reserved next QDMA queue is taken as the current QDMA queue, and the step that before the current first data hash is allocated to the current QDMA queue, whether the cumulative bandwidth of the current QDMA queue after the current first data hash is allocated thereto exceeds the set processing bandwidth of a single CPU core is determined is executed, until all the first data hashes are allocated to the reserved QDMA queues, and it is satisfied that the cumulative bandwidth (the cumulative bandwidth in this case is the sum of the bandwidths of the allocated first data hashes) in each QDMA does not exceed the processing bandwidth of a single CPU core;
if the cumulative bandwidth of the current QDMA queue after the current first data hash is allocated thereto exceeds the set processing bandwidth of a single CPU core, the next data hash is taken as the current data hash in a descending order of bandwidths, and the step that before the current first data hash is allocated to the current QDMA queue, whether the cumulative bandwidth of the current QDMA queue after the current first data hash is allocated thereto exceeds the set processing bandwidth of a single CPU core is determined is executed, until all the first data hashes are allocated to the reserved QDMA queues.

By means of the described process, each first data hash can be sequentially allocated to a reserved QDMA queue, so that data with approximately the same cumulative bandwidth is allocated to each reserved QDMA queue, and the cumulative bandwidth in each reserved QDMA queue does not exceed the set processing bandwidth of a single CPU core.

According to the traffic management and control method provided in an embodiment of the present disclosure, when a bandwidth of data in a data frame sent from a single kernel of the heterogeneous accelerator does not exceed the processing capability of a single CPU core, and the total bandwidth of data in data frames sent from a plurality of kernels is greater than a second preset value, selecting a target traffic management and control mode corresponding to data in the data frame from a plurality of preset traffic management and control modes may include:
selecting an RSS hash dynamic extension mode from the plurality of preset traffic management and control modes as a target traffic management and control mode corresponding to the data in the data frame;
managing and controlling the data in the data frame according to the target traffic management and control mode, so as to allocate the data to a QDMA queue, send the data by means of the QDMA queue may include:
merging the data in the data frames sent from the plurality of kernels, and performing RSS hashing on the merged data to obtain second data hashes; performing bandwidth statistics on each second data hash, and allocating the second data hash to a first QDMA queue in a descending order of bandwidths, and if obtaining by means of calculation, before a current second data hash is allocated, that the cumulative bandwidth of the first QDMA queue after the current second data hash is allocated thereto exceeds the set processing bandwidth of a single CPU core, starting a next QDMA queue, and allocating the remaining second data hashes to the newly enabled QDMA queue in a descending order of bandwidths, until all the second data hashes are completely allocated; wherein the cumulative bandwidth in each QDMA queue does not exceed the set processing bandwidth of a single CPU core;
sending, by means of the QDMA queue to which the second data hash is allocated, the corresponding second data hash to a cache region corresponding to the QDMA queue in a system memory, so that the CPU core pre-bound to the QDMA queue acquires data from the corresponding cache region and processes the data.

In an embodiment, when a target traffic management and control mode corresponding to data in the data frame is selected from a plurality of preset traffic management and control modes, if a target traffic management and control mode corresponding to data in the data frame is automatically selected from the plurality of preset traffic management and control modes according to a bandwidth of data in the data frame, when the total bandwidth of data in the data frames sent from a plurality of kernels of the heterogeneous accelerator is greater than a second preset value (the specific magnitude thereof is set according to practical experience, and the bandwidth being greater than the second preset value indicates a CPU response requirement with a high bandwidth) and the bandwidth of data in the data frame sent from the single kernel of the heterogeneous accelerator does not exceed the processing capability of a single CPU core, and the bandwidth of data in data frames sent from a plurality of such kernels exceeds the processing capability of a single CPU core, an RSS hash dynamic extension mode is selected from the plurality of preset traffic management and control modes as a target traffic management and control mode corresponding to the data in the data frame.

Correspondingly, when the data in the data frame is managed and controlled according to the target traffic management and control mode, so as to allocate the data to a QDMA queue, and send the data by means of the QDMA queue, the data in the data frames sent from a plurality of kernels (the kernels mentioned herein specifically are kernels where the bandwidth of the data in the data frames sent therefrom does not exceed the processing capability of a single CPU core) may be merged first, and then RSS hashing is performed on the merged data to obtain second data hashes, wherein when RSS hashing is performed, the number of hashes may be designated, so that RSS hashing is performed according to the designated number of hashes, so as to obtain second data hashes with the designated number of hashes. Thereafter, the second data hashes obtained by hashing can be allocated to a first QDMA queue in a descending order of bandwidths, and if obtaining by means of calculation, before a current second data hash is allocated, that the cumulative bandwidth of the first QDMA queue after the current second data hash is allocated thereto exceeds the set processing bandwidth of a single CPU core, a next QDMA queue is started, and the remaining second data hashes are allocated to the newly enabled QDMA queue in a descending order of bandwidths, until all the second data hashes are completely allocated; wherein the cumulative bandwidth in each QDMA queue does not exceed the set processing bandwidth of a single CPU core.

The specific process of allocating the second data hashes is as follows: first, a first second data hash obtained by hashing is taken as a current second data hash in a descending order of bandwidths; then, before the current second data hash is allocated to a first QDMA queue, whether the cumulative bandwidth of the first QDMA queue after the current second data hash is allocated thereto exceeds the set processing bandwidth of a single CPU core is first determined; if the cumulative bandwidth of the first QDMA queue after the current second data hash is allocated thereto does not exceed the set processing bandwidth of a single CPU core, the current second data hash is allocated to the first QDMA queue; then, the next second data hash obtained by hashing is taken as the current second data hash in a descending order of bandwidths, and the step that whether the cumulative bandwidth of the first QDMA queue after the current second data hash is allocated thereto exceeds the set processing bandwidth of a single CPU core is first determined is executed. If the cumulative bandwidth of the first QDMA queue after the current second data hash is allocated thereto exceeds the set processing bandwidth of a single CPU core, the next QDMA queue is enabled, and before the current second data hash is allocated to the newly enabled QDMA queue, whether the cumulative bandwidth of the newly enabled QDMA queue after the current second data hash is allocated thereto exceeds the set processing bandwidth of a single CPU core is determined; if the cumulative bandwidth of the newly enabled QDMA queue after the current second data hash is allocated thereto does not exceed the set processing bandwidth of a single CPU core, the current second data hash is allocated to the newly enabled QDMA queue, and the next second data hash obtained by hashing is taken as the current second data hash in a descending order of bandwidths, and the step that before the current second data hash is allocated to the newly enabled QDMA queue, whether the cumulative bandwidth of the newly enabled QDMA queue after the current second data hash is allocated thereto exceeds the set processing bandwidth of a single CPU core is determined is executed; and if the cumulative bandwidth of the newly enabled QDMA queue after the current second data hash is allocated thereto exceeds the set processing bandwidth of a single CPU core, the step of enabling the next QDMA queue is executed, until all the second data hashes are allocated. That is to say, when the second data hash is allocated in an RSS hash dynamic extension mode, the principle is to make full use of the bandwidth of the existing QDMA queue as far as possible, and in the case where the previous QDMA queue cannot receive a new second data hash, the new QDMA queue is started.

After the allocation of the second data hash is completed, the corresponding second data hash may be sent, by means of the QDMA queue to which the second data hash is allocated, to a cache region corresponding to the QDMA queue in a system memory, so that the corresponding second data hash is cached by using the cache region corresponding to the QDMA, and the CPU core pre-bound to the QDMA queue by using the affinity of the CPU acquires data from the corresponding cache region (specifically, acquiring the second data hash), and processes the acquired data. Specifically, a QDMA queue may be bound to a CPU core by using affinity of a CPU in software of a host system (specifically, a queue number of a QDMA queue may be bound to a core number of a CPU core), so as to implement allocation of CPU processing resources on the basis of a binding relationship.

In addition, as the bandwidth (i.e. data traffic) of data sent by the data frame changes continuously, statistics update may be performed on the bandwidth of each second data hash, wherein the frequency at which statistics update is performed on the bandwidth of each second data hash is not lower than 10 Hz, so as to adjust and update the QDMA queue allocation for each first data hash on the basis of the bandwidth of each second data hash on which statistics update has been performed.

By means of the described process, data in data frames sent from a plurality of kernels can be allocated to QDMA allocation in a dynamic and shared manner, and a CPU core bound to a QDMA queue performs scheduling processing, so as to maximally ensure that a bandwidth satisfy an application requirement to the maximum extent. In addition, a plurality of cores of a CPU are configured into a plurality of QDMA queues as required by means of the introduction of an RSS hash dynamic extension mode and the traffic management and control according to the mode, thereby realizing the coordinated configuration of the CPU and the heterogeneous accelerator capabilities. It should be noted that, the RSS hash dynamic extension in FIG. 2 corresponds to the RSS hash dynamic extension mode mentioned above in the present disclosure.

According to the method for traffic management and control provided in an embodiment of the present disclosure, when a required delay of data in the data frame sent from a single kernel of the heterogeneous accelerator is less than a third preset value and a bandwidth of the data does not exceed the processing capability of a single CPU core, selecting a target traffic management and control mode corresponding to data in the data frame from a plurality of preset traffic management and control modes may include:
selecting a designated queue direct mapping mode from the plurality of preset traffic management and control modes as a target traffic management and control mode corresponding to the data in the data frame;
managing and controlling the data in the data frame according to the target traffic management and control mode, so as to allocate the data to a QDMA queue, send the data by means of the QDMA queue may include:
directly distributing the data in the data frame sent from each kernel to a designated QDMA queue, and sending, by means of the QDMA queue, the data to a cache region corresponding to the QDMA queue in a system memory, so that the CPU core pre-bound to the QDMA queue acquires data from the corresponding cache region and processes the data.

In an embodiment, when a target traffic management and control mode corresponding to data in the data frame is selected from a plurality of preset traffic management and control modes, if a target traffic management and control mode corresponding to data in the data frame is automatically selected from the plurality of preset traffic management and control modes according to a delay of data in the data frame, when the required delay of data in the data frame sent from a single kernel of the heterogeneous accelerator is lower than a third preset value (the specific magnitude thereof is set according to practical experience, and the delay being lower than the third preset value indicates a CPU response requirement with a low delay) and the bandwidth of data in the data frame sent from the single kernel does not exceed the processing capability of a single CPU core, a designated queue direct mapping mode is selected from the plurality of preset traffic management and control modes as the target traffic management and control mode corresponding to the data in the data frame.

Correspondingly, when the data in the data frame is managed and controlled according to the target traffic management and control mode, so as to allocate the data to a QDMA queue, and send the data by means of the QDMA queue, the data frame sent from each kernel is directly allocated to a designated QDMA queue, and then the data is sent, by means of the QDMA queue, to a cache region corresponding to the designated QDMA in a system memory, so that operations such as RSS hashing are not performed any more, thereby enabling data to be transmitted to the CPU as soon as possible. Based on the foregoing description, the CPU core pre-bound to the QDMA queue by using the affinity of the CPU acquires data from the corresponding cache region, and processes the acquired data. Specifically, a QDMA queue may be bound to a CPU core by using affinity of a CPU in software of a host system (specifically, a queue number of a QDMA queue may be bound to a core number of a CPU core), so as to implement allocation of CPU processing resources on the basis of a binding relationship.

By means of the described process, data with a low delay requirement and a small transmission amount can be directly allocated to a QDMA queue, and a CPU core bound to a designated QDMA queue performs scheduling processing (i.e. a designated CPU core performs scheduling processing), thereby maximally ensuring that a bandwidth and a processing delay satisfy an application requirement. It should be noted that, the designated queue direct mapping in FIG. 2 corresponds to the designated queue direct mapping mentioned above in the present disclosure.

According to the method for traffic management and control provided in an embodiment of the present disclosure, when it is required that a bandwidth of data in a data frame sent from a single kernel of the heterogeneous accelerator does not exceed a fourth preset value, selecting a target traffic management and control mode corresponding to data in the data frame from a plurality of preset traffic management and control modes may include:
selecting a queue bandwidth rate-limiting mode from the plurality of preset traffic management and control modes as a target traffic management and control mode corresponding to the data in the data frame;
managing and controlling the data in the data frame according to the target traffic management and control mode, so as to allocate the data to a QDMA queue, send the data by means of the QDMA queue may include:
limiting the bandwidth of the data by using a token bucket algorithm, and sending the data after the bandwidth is limited to a designated QDMA queue;
sending the data after the bandwidth is limited to a system memory by means of the QDMA queue, and scheduling a CPU core, so that the scheduled CPU core acquires data from the system memory and processes the data.

In an embodiment, when a target traffic management and control mode corresponding to data in the data frame is selected from a plurality of preset traffic management and control modes, if a target traffic management and control mode corresponding to data in the data frame is automatically selected from the plurality of preset traffic management and control modes according to a bandwidth of data in the data frame, when it is required that the bandwidth of the data in the data frame sent from a single kernel of the heterogeneous accelerator does not exceed a fourth preset value (the magnitude of the fourth preset value is set according to actual requirements, and requiring that the bandwidth does not exceed the fourth preset value indicates that the use of the bandwidth of a single kernel is limited), a queue bandwidth rate-limiting mode may be selected from the plurality of preset traffic management and control modes as a target traffic management and control mode corresponding to the data in the data frame, and the data traffic of one or more kernels can be received in this target traffic management and control mode.

Correspondingly, when the data in the data frame is managed and controlled according to the target traffic management and control mode, so as to allocate the data to a QDMA queue, and send the data by means of the QDMA queue, although the data traffic of one or more kernels can be received, the bandwidth of data passed is limited by using the token bucket algorithm, and the data with the limited bandwidth is sent to the designated QDMA queue. Then, the data after the bandwidth is limited is sent to a system memory by means of the designated QDMA queue, and an available CPU core is scheduled from the system, so that the scheduled CPU core acquires data from the system memory and processes the acquired data.

From the described process, it can be determined that if the use of the bandwidth of a kernel inside a certain heterogeneous accelerator is limited, a rate-limiting queue sharing the bandwidth is provided in a shell, and best-effort transmission services are provided for all kernels using the queue, the queue has no assigned CPU core resource and is freely scheduled by system software, which can reduce interference to the processing of other data streams. In addition, on the basis of the implementation of introducing a queue bandwidth rate-limiting function into a heterogeneous accelerator shell, the control strength of an FPGA accelerator on network burst traffic can be enhanced, so as to effectively reduce the impact of low-priority burst service traffic on the system load. It should be noted that, the queue bandwidth rate-limiting in FIG. 2 corresponds to the queue bandwidth rate-limiting mode in the present disclosure.

From the described management and control of data in different situations according to a plurality of traffic management and control modes respectively, it can be determined that the process of traffic management and control in the present disclosure achieves matching of the traffic of a heterogeneous accelerator kernel and the processing capability of a CPU, maximally ensures acquisition of a required processing bandwidth for the network traffic, and also improves the processing delay of a service flow with a high QoS (Quality of Service) level, that is, by introducing the service flow bandwidth management and control function into the design of a shell of a heterogeneous accelerator, the service flow can obtain a CPU operation resource matching the QoS level. In addition, it should be noted that, in view of the described process and FIG. 2, the design of shell supporting traffic management and control is only related to use of a QDMA queue, wherein a PCIe hard core IP and a QDMA part are inherent designs in the shell, and the others are newly added designs.

The method for traffic management and control provided in an embodiment of the present disclosure may further include:
recording a queue number of a QDMA queue to which the data is allocated and a virtual source port included in the data frame, so as to obtain record information; and
when the CPU sends a data stream to the heterogeneous accelerator, sending data in the data stream to a corresponding heterogeneous accelerator kernel according to the record information.

In an embodiment, after the data in the data frame is managed and controlled according to the target traffic management and control mode, so as to allocate the data to a QDMA queue, a queue number of a QDMA queue to which the data is allocated and a virtual source port included in the data frame may be recorded, so as to obtain the record information. Specifically, the describing information may be recorded in a reverse port mapping module shown in FIG. 2, that is, an original port mapping relationship is recorded by using the reverse port mapping module, and based on this, a data stream sent from a CPU (i.e. a data stream in Host to Card (H2C) direction, and the data stream in H2C direction relative to C2H direction is a data stream in opposite direction) can be correctly forwarded to an original heterogeneous accelerator kernel.

When a CPU sends a data stream to a heterogeneous accelerator, the CPU selects a QDMA queue for sending. As QDMA queues for sending and receiving are used in pairs, when data sent by the CPU passes through a reverse port mapping module, a virtual source port number used by the data stream in C2H direction can be obtained by querying record information, and a virtual source port number used by the data stream in H2C direction is used as a virtual destination port number, so as to send data in the data stream back to a correct heterogeneous accelerator kernel, thereby realizing that data sent from a heterogeneous accelerator kernel can be sent back to that heterogeneous accelerator kernel during reverse data stream sending.

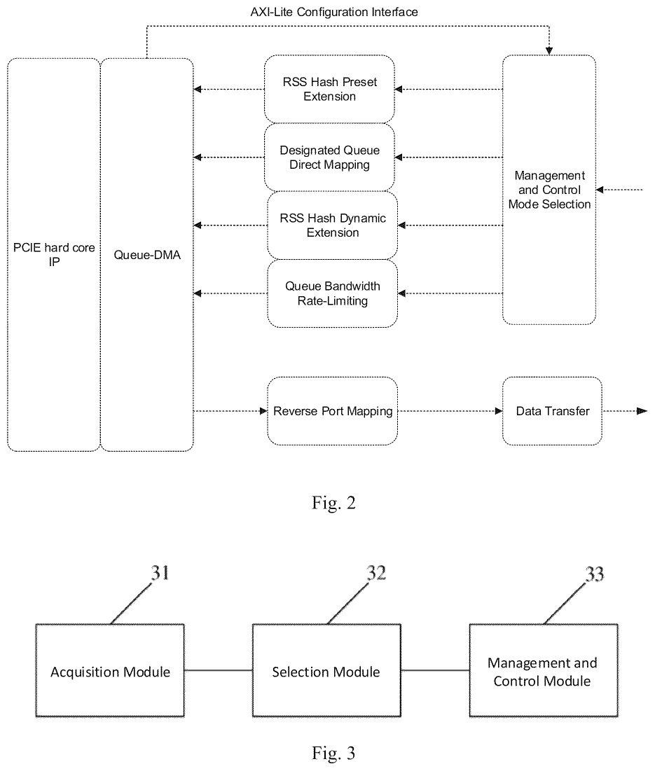

An embodiment of the present disclosure also provides an apparatus for traffic management and control. FIG. 3 shows a schematic structural diagram of an apparatus for traffic management and control provided in an embodiment of the present disclosure, which may include:
an acquisition module 31, configured to acquire a data frame sent from a heterogeneous accelerator;
a selection module 32, configured to select a target traffic management and control mode corresponding to data in the data frame from a plurality of preset traffic management and control modes; and
a management and control module 33, configured to manage and control the data in the data frame according to the target traffic management and control mode, so as to allocate the data to a QDMA queue, and send the data by means of the QDMA queue, and process the data by a corresponding CPU core.

According to the apparatus for traffic management and control provided in an embodiment of the present disclosure, when a bandwidth of data in a data frame sent from a single kernel of the heterogeneous accelerator does not exceed a fourth preset value, the selection module 32 may include:
a fourth selection unit, configured to select a queue bandwidth rate-limiting mode from the plurality of preset traffic management and control modes as a target traffic management and control mode corresponding to the data in the data frame;
the management and control module 33 may include:
a limiting module, configured to limit the bandwidth of the data by using a token bucket algorithm, and send the data after the bandwidth is limited to a designated QDMA queue; and
a second sending unit, configured to send the data after the bandwidth is limited to a system memory by means of the QDMA queue, and schedule a CPU core, so that the scheduled CPU core acquires data from the system memory and processes the data.

The traffic management and control apparatus provided in an embodiment of the present disclosure may further include:
a recording module, configured to record a queue number of a QDMA queue to which the data is allocated and a virtual source port included in the data frame, so as to obtain record information; and
a sending module, configured to send, when the CPU sends a data stream to the heterogeneous accelerator, data in the data stream to a corresponding heterogeneous accelerator kernel according to the record information.

It should be noted that, for a specific limitation to the described apparatus for traffic management and control, reference may be made to the limitation to the traffic management and control method in the foregoing, and details are not repeatedly described herein. All or some of the modules in the described traffic management and control apparatus may be implemented by software, hardware, or a combination thereof. The foregoing modules may be embedded in or independent of a processor in the device for traffic management and control in a hardware form, and may also be stored in one or more memories in the device for traffic management and control in a software form, so as to be invoked by the processor to execute operations corresponding to the foregoing modules.

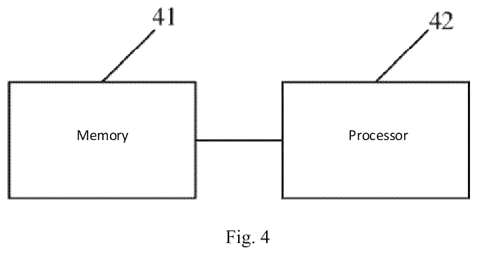

An embodiment of the present disclosure also provides a device for traffic management and control. FIG. 4 shows a schematic structural diagram of a device for traffic management and control provided in an embodiment of the present disclosure, which may include:
a memory 41, configured to store computer readable instructions;
one or more processors 42, configured to implement steps in the traffic management and control method provided in any one of the foregoing embodiments when executing the computer readable instructions stored in the memory 41.

An embodiment of the present disclosure further provides a non-transitory computer readable storage medium. The non-transitory computer readable storage medium stores computer readable instructions, and when one or more processors execute the computer readable instructions, the steps in the traffic management and control method provided in any one of the foregoing embodiments can be implemented.

The non-transitory computer readable storage medium includes: any medium that can store program codes, such as a USB flash disk, a removable hard disk, a read-only memory (ROM), a random access memory (RAM), a magnetic disk, or an optical disk.

For description of related parts in the apparatus and device for traffic management and control, and the readable storage medium provided in the present disclosure, reference may be made to detailed description of corresponding parts in the method for traffic management and control provided in an embodiment of the present disclosure, and details are not repeatedly described herein.

It should be noted that, in this description, relationship terms such as first and second are merely used to distinguish one entity or operation from another entity or operation, and do not necessarily require or imply any actual relationship or sequence between these entities or operations. Moreover, the terms “comprise” and “include” or any other variation thereof, are intended to cover a non-exclusive inclusion, so that elements inherent to a process, a method, an article, or a device are comprised. Without more limitations, an element limited by “comprise a . . . ” does not exclude other same elements also existing in a process, a method, an article, or a device that comprises the element. In addition, the part of the described technical solutions provided in the embodiments of the present disclosure that has a consistent implementation principle with corresponding technical solutions in the prior art is not described in detail, in order to avoid redundant description.

The above descriptions of the disclosed embodiments enable a person skilled in the art to implement or use the present disclosure. Various modifications to these embodiments would have readily occurred to those skilled in the art. The general principles defined herein may be implemented in other embodiments without departing from the spirit or scope of the present disclosure. Accordingly, the present disclosure will not be limited to the embodiments shown herein but is to be in accord with the widest scope consistent with the principles and novel features disclosed herein.

1. A method for traffic management and control, comprising:
acquiring a data frame sent from a heterogeneous accelerator;
selecting a target traffic management and control mode corresponding to data in the data frame from a plurality of preset traffic management and control modes; and
managing and controlling the data in the data frame according to the target traffic management and control mode, so as to allocate the data to a QDMA queue, and send the data by the QDMA queue, and process the data by a corresponding CPU core.

2. The method for traffic management and control according to claim 1, wherein when a bandwidth of the data in the data frame sent from a single kernel of the heterogeneous accelerator is greater than a first preset value and exceeds a processing capability of a single CPU core, selecting the target traffic management and control mode corresponding to the data in the data frame from a plurality of the preset traffic management and control modes, comprising:
selecting an RSS hash preset extension mode from the plurality of the preset traffic management and control modes as the target traffic management and control mode corresponding to the data in the data frame:
managing and controlling the data in the data frame according to the target traffic management and control mode, so as to allocate the data to the QDMA queue, send the data by the QDMA queue, comprising:
obtaining a minimum required number of CPU cores according to a maximum processing bandwidth and a set processing bandwidth of the single CPU core, and reserving CPU cores and QDMA queues according to the minimum required number of CPU cores;
performing RSS hashing on the data in the data frame according to the number of reserved CPU cores to obtain first data hashes; and
allocating each first data hash to a reserved QDMA queue, and sending, by the QDMA queue, the first data hash to a cache region corresponding to the QDMA queue in a system memory, so that the CPU core pre-bound to the QDMA queue acquires data from the corresponding cache region and processes the data: wherein the cumulative bandwidth in each reserved QDMA queue does not exceed the set processing bandwidth of the single CPU core.

3. The method for traffic management and control according to claim 2, wherein performing RSS hashing on the data in the data frame according to the number of reserved CPU cores, comprising:
performing RSS hashing on the data in the data frame according to N times the number of the reserved CPU cores: where N is an integer greater than 1;
before allocating each first data hash to a reserved QDMA queue, further comprising: performing bandwidth statistics on each first data hash, and regularly performing statistics update on the bandwidth of each first data hash;
allocating each first data hash to the reserved QDMA queue, comprising:
sequentially allocating each first data hash to the reserved QDMA queue in a descending order of bandwidths: wherein before a current first data hash is allocated to a current QDMA queue, whether the cumulative bandwidth of the current QDMA queue after the current first data bash is allocated thereto exceeds the set processing bandwidth of a single CPU core is determined:
in response to that the cumulative bandwidth of the current QDMA queue after the current first data hash is allocated thereto does not exceed the set processing bandwidth of a single CPU core, allocating the current first data hash to the current QDMA queue; taking the next first data hash as the current first data bash, and taking the reserved next QDMA queue as the current QDMA queue, executing the step that before the current first data hash is allocated to the current QDMA queue, whether the cumulative bandwidth of the current QDMA queue after the current first data hash is allocated thereto exceeds the set processing bandwidth of a single CPU core is determined, until all the first data hashes are allocated to the reserved QDMA queues; or, in response to that the cumulative bandwidth of the current QDMA queue after the current first data hash is allocated thereto exceeds the set processing bandwidth of the single CPU core, taking the reserved next QDMA queue as the current QDMA queue, and executing the step that before the current first data hash is allocated to the current QDMA queue, whether the cumulative bandwidth of the current QDMA queue after the current first data hash is allocated thereto exceeds the set processing bandwidth of the single CPU core is determined.

4. The method for traffic management and control according to claim 1, wherein when a bandwidth of the data in the data frame sent from a single kernel of the heterogeneous accelerator does not exceed the processing capability of a single CPU core, and the total bandwidth of the data in the data frames sent from a plurality of kernels is greater than a second preset value, selecting the target traffic management and control mode corresponding to the data in the data frame from a plurality of the preset traffic management and control modes, comprising:
selecting an RSS hash dynamic extension mode from the plurality of preset traffic management and control modes as the target traffic management and control mode corresponding to the data in the data frame;
managing and controlling the data in the data frame according to the target traffic management and control mode, so as to allocate the data to the QDMA queue, send the data by the QDMA queue, comprising:
merging the data in the data frames sent from the plurality of kernels, and performing RSS hashing on the merged data to obtain second data hashes;
performing bandwidth statistics on each second data hash, and allocating the second data hash to a first QDMA queue in a descending order of bandwidths, and in response to obtaining by means of calculation, before a current second data hash is allocated, that the cumulative bandwidth of the first QDMA queue after the current second data hash is allocated thereto exceeds the set processing bandwidth of the single CPU core, starting a next QDMA queue, and allocating the remaining second data hashes to the newly enabled QDMA queue in the descending order of bandwidths, until all the second data hashes are completely allocated: wherein the cumulative bandwidth in each QDMA queue does not exceed the set processing bandwidth of the single CPU core; and
sending, by the QDMA queue to which the second data bash is allocated, the corresponding second data hash to the cache region corresponding to the QDMA queue in the system memory, so that the CPU core pre-bound to the QDMA queue acquires data from the corresponding cache region and processes the data.

5. The method for traffic management and control according to claim 1, wherein when a required delay of the data in the data frame sent from the single kernel of the heterogeneous accelerator is less than a third preset value and a bandwidth of the data does not exceed the processing capability of a single CPU core, selecting a target traffic management and control mode corresponding to data in the data frame from a plurality of preset traffic management and control modes, comprising:
selecting a designated queue direct mapping mode from the plurality of the preset traffic management and control modes as the target traffic management and control mode corresponding to the data in the data frame;
managing and controlling the data in the data frame according to the target traffic management and control mode, so as to allocate the data to the QDMA queue, send the data by the QDMA queue, comprising:
directly distributing the data in the data frame sent from each kernel to a designated QDMA queue, and sending, by the QDMA queue, the data to the cache region corresponding to the QDMA queue in the system memory, so that the CPU core pre-bound to the QDMA queue acquires data from the corresponding cache region and processes the data.

6. The method for traffic management and control according to claim 1, wherein when it is required that a bandwidth of the data in the data frame sent from a single kernel of the heterogeneous accelerator does not exceed a fourth preset value, selecting the target traffic management and control mode corresponding to the data in the data frame from a plurality of the preset traffic management and control modes, comprising:
selecting a queue bandwidth rate-limiting mode from the plurality of the preset traffic management and control modes as the target traffic management and control mode corresponding to the data in the data frame;
managing and controlling the data in the data frame according to the target traffic management and control mode, so as to allocate the data to the QDMA queue, send the data by the QDMA queue, comprising:
limiting the bandwidth of the data by using a token bucket algorithm, and sending the data after the bandwidth is limited to the designated QDMA queue; and
sending the data after the bandwidth is limited to the system memory by the QDMA queue, and scheduling the CPU core, so that the scheduled CPU core acquires data from the system memory and processes the data.

7. The method for traffic management and control according to claim 1, further comprising: recording a queue number of the QDMA queue to which the data is allocated and a virtual source port included in the data frame, so as to obtain record information; and
when the CPU sends a data stream to the heterogeneous accelerator, sending the data in the data stream to a corresponding heterogeneous accelerator kernel according to the record information.

8. (canceled)

9. A device for traffic management and control, comprising:
a memory, configured to store computer readable instructions; and
one or more processors, configured to execute the computer readable instructions to:
acquire a data frame sent from a heterogeneous accelerator;
select a target traffic management and control mode corresponding to data in the data frame from a plurality of preset traffic management and control modes; and
manage and control the data in the data frame according to the traffic management and control mode, so as to allocate the data to a QDMA queue, and sent the data by the QDMA queue, and process the data by a corresponding CPU core.

10. A non-transitory computer readable storage medium storing one or more computer readable instructions, wherein the computer readable instructions, when executed by one or more processors, cause the one or more processors to:
acquire a data frame sent from a heterogeneous accelerator;
select a target traffic management and control mode corresponding to data in the data frame from a plurality of preset traffic management and control modes; and
manage and control the data in the data frame according to the traffic management and control mode, so as to allocate the data to a QDMA queue, and sent the data by the QDMA queue, and process the data by a corresponding CPU core.

11. The method for traffic management and control according to claim 1, wherein acquiring the data frame sent from a heterogeneous accelerator, comprising:
acquiring the data frame in a C2H direction sent from a kernel of the heterogeneous accelerator.

12. The method for traffic management and control according to claim 1, wherein the data frame may further carry information about a virtual destination port and a virtual source port.

13. The method for traffic management and control according to claim 1, wherein selecting the target traffic management and control mode, comprising:
selecting the target management and control mode corresponding to the data in the data frame from a plurality of preset traffic management and control modes according to a bandwidth or a delay of the data in the data frame; or
receiving the target traffic management and control mode selection instruction, and selecting the target traffic management and control mode corresponding to data in the data frame from a plurality of preset traffic management and control modes according to the target traffic management and control mode selection instruction.

14. The method for traffic management and control according to claim 1, wherein selecting the target traffic management and control mode, comprising:
recommending, by a system, according to the bandwidth and the delay of data in the data frame, the traffic management and control mode which is most adapted to the data in the data frame from the plurality of preset traffic management and control modes.

15. The method for traffic management and control according to claim 2, wherein selecting the target traffic management and control mode corresponding to the data in the data frame from a plurality of preset traffic management and control modes, comprising:
selecting an RSS hash mode from the plurality of preset traffic management and control modes as the target traffic management and control mode corresponding to the data in the data frame, when the bandwidth of data in the data frame sent from the single kernel of the heterogeneous accelerator is greater than the first preset value, and the bandwidth of the data in the data frame sent from the single kernel of the heterogeneous accelerator exceeds the processing capability of the single CPU core.

16. The method for traffic management and control according to claim 4, wherein selecting the target traffic management and control mode corresponding to the data in the data frame from a plurality of preset traffic management and control modes, comprising:
selecting an RSS hash dynamic extension mode from the plurality of preset traffic management and control modes as the target traffic management and control mode corresponding to the data in the data frame, when the total bandwidth of data in the data frames sent from a plurality of kernels of the heterogeneous accelerator is greater than a second preset value, and the bandwidth of the data in the data frame sent from the single kernel of the heterogeneous accelerator does not exceed the processing capability of the single CPU core, and the bandwidth of data in data frames sent from a plurality of such kernels exceeds the processing capability of the single CPU core.

17. The method for traffic management and control according to claim 5, wherein selecting the target traffic management and control mode corresponding to the data in the data frame from a plurality of preset traffic management and control modes, comprising:
selecting a designated queue direct mapping mode from the plurality of preset traffic management and control modes as the target traffic management and control mode corresponding to the data in the data frame, when the required delay of the data in the data frame sent from the single kernel of the heterogeneous accelerator is lower than a third preset value, and the bandwidth of the data in the data frame sent from the single kernel does not exceed the processing capability of a single CPU core.

18. The method for traffic management and control according to claim 9, wherein when a bandwidth of the data in the data frame sent from a single kernel of the heterogeneous accelerator is greater than a first preset value and exceeds a processing capability of a single CPU core, the one or more processors is further configured to:
select an RSS hash preset extension mode from the plurality of the preset traffic management and control modes as the target traffic management and control mode corresponding to the data in the data frame;
obtain a minimum required number of CPU cores according to a maximum processing bandwidth and a set processing bandwidth of the single CPU core, and reserving CPU cores and QDMA queues according to the minimum required number of CPU cores;
perform RSS hashing on the data in the data frame according to the number of reserved CPU cores to obtain first data hashes; and
allocate each first data hash to a reserved QDMA queue, and send, by the QDMA queue, the first data hash to a cache region corresponding to the QDMA queue in a system memory, so that the CPU core pre-bound to the QDMA queue acquires data from the corresponding cache region and processes the data; wherein the cumulative bandwidth in each reserved QDMA queue does not exceed the set processing bandwidth of the single CPU core.

19. The device for traffic management and control according to claim 18, wherein the one or more processors is further configured to:
perform RSS hashing on the data in the data frame according to N times the number of the reserved CPU cores; where N is an integer greater than 1;
perform bandwidth statistics on each first data hash, and perform statistics update on the bandwidth of each first data hash;
allocate each first data hash to the reserved QDMA queue in a descending order of bandwidths; wherein before a current first data hash in allocated to a current QDMA queue, whether the cumulative bandwidth of the current QDMA queue after the current first data hash is allocated thereto exceeds the set processing bandwidth of a single CPU core is determined;
in response to that the cumulative bandwidth of the current QDMA queue after the current first data hash is allocated thereto dose not exceed the set processing bandwidth of a single CPU core, allocate the current first data hash to the current QDMA queue; take the next first data hash as the current first data hash, and take the reserved next QDMA queue as the current QDMA queue, execute the step that before the current first data hash is allocated to the current QDMA queue, whether the cumulative bandwidth of the current QDMA queue after the current first data hash is allocated thereto exceeds the set processing bandwidth of a single CPU core is determined, until all the first data hashes are allocated to the reserved QDMA queues; or, in response to that the cumulative bandwidth of the current QDMA queue after the current first data hash is allocated thereto exceeds the set processing bandwidth of the single CPU core, take the reserved next QDMA queue as the current QDMA queue, and execute the step that before the current first data hash is allocated to the current QDMA queue, whether the cumulative bandwidth of the current QDMA queue after the current first data hash is allocated thereto exceeds the set processing bandwidth of the single CPU core is determined.

20. The device for traffic management and control according to claim 9, wherein when a bandwidth of the data in the data frame sent from a single kernel of the heterogeneous accelerator does not exceed the processing capability of a single CPU core, and the total bandwidth of the data in the data frames sent from a plurality of kernels is greater than a second preset value, the one or more processors is further configured to:
select an RSS hash dynamic extension mode from the plurality of preset traffic management and control modes as the target traffic management and control mode corresponding to the data in the data frame;
merge the data in the data frames sent from the plurality of kernels, and perform RSS hashing on the merged data to obtain second data hashes;
perform bandwidth statistics on each second data hash, and allocate the second hash to a first QDMA queue in a descending order of bandwidths, and in response to obtaining by means of calculation, before a current second data hash is allocated, that the cumulative bandwidth of the first QDMA queue after the current second data hash is allocated thereto exceeds the set processing bandwidth of the single CPU core, start a next QDMA queue, and allocate the remaining second data hashed to the newly enabled QDMA queue in the descending order of bandwidths, until all the second data hashes are completely allocated; wherein the cumulative bandwidth in each QDMA queue does not exceed the set processing bandwidth of the single CPU core; and
send, by the QDMA queue to which the second data hash is allocated, the corresponding second data hash to the cache region corresponding to the QDMA queue in the system memory, so that the CPU core pre-bound to the QDMA queue acquires data from the corresponding cache region and processes the data.

21. The device for traffic management and control according to claim 9, wherein when a required delay of the data in the data frame sent from the single kernel of the heterogeneous accelerator is less than a third preset value and a bandwidth of the data does not exceed the processing capability of a single CPU core, the one or more processors is further configured to:
select a designated queue direct mapping mode from the plurality of the preset traffic management and control modes as the target traffic management and control mode corresponding to the data in the data frame;
distribute the data in the data frame sent from each kernel to a designated QDMA queue, and send, by the QDMA queue, the data to the cache region corresponding to the QDMA queue in the system memory, so that the CPU core pre-bound to the QDMA queue acquires data from the corresponding cache region and processes the data.
